(19) United States
(12) Patent Application Publication
(10) Pub. No.: US 2022/0036141 A1
(43) Pub. Date: Feb. 3, 2022

(54) TARGET OBJECT IDENTIFICATION METHOD AND APPARATUS

(71) Applicant: SENSETIME INTERNATIONAL PTE. LTD., Singapore (SG)

(72) Inventors: Maoqing TIAN, Singapore (SG); Jin WU, Singapore (SG); Shuai YI, Singapore (SG)

(21) Appl. No.: 17/343,154

(22) Filed: Jun. 9, 2021

Related U.S. Application Data
(63) Continuation of application No. PCT/IB2020/061574, filed on Dec. 7, 2020.

(30) Foreign Application Priority Data
Aug. 1, 2020 (SG) 10202007348T

(51) Int. Cl. G06K 9/62; G06K 9/42; G06K 9/46; G06K 9/32; G06K 9/00; G06N 3/04

(52) U.S. Cl. CPC G06K 9/6276; G06K 9/6262; G06K 9/42; G06N 3/04; G06K 9/6232; G06K 9/32; G06K 9/00624; G06K 9/46

(57) ABSTRACT

Methods, devices, systems, and apparatus for target object identification are provided. In one aspect, a method includes: performing classification on a to-be-identified target object in a target image to determine a prediction category of the to-be-identified target object, determining whether the prediction category is correct according to a hidden layer feature for the to-be-identified target object, and outputting prompt information in response to the prediction category being incorrect.

### CROSS REFERENCE TO RELATED APPLICATIONS

The present application is a continuation application of International Application No. PCT/IB2020/061574, filed on Dec. 7, 2020, which claims a priority of the Singaporean patent application No. 10202007348T filed on Aug. 1, 2020, all of which are incorporated herein by reference in their entirety.

### TECHNICAL FIELD

The present disclosure relates to the field of computer vision technologies, and in particular to, target object identification methods and apparatuses.

### BACKGROUND

In daily production and life, it is often necessary to identify some target objects. Taking an entertainment scene of table games as an example, in some table games, game coins on a table need to be identified to obtain the category and quantity information of the game coins. However, the conventional identification modes are relatively low in identification accuracy, and cannot determine target objects that do not belong to a current scene.

### SUMMARY

Implementations of the present disclosure provide methods, devices, systems, and apparatus for target object identification.

One aspect of the present disclosure features a target object identification method, including: performing classification on a to-be-identified target object in a target image to determine a prediction category of the to-be-identified target object; determining whether the prediction category is correct according to a hidden layer feature for the to-be-identified target object; and outputting prompt information in response to the prediction category being incorrect.

In some implementations, the method further includes: in response to the prediction category being correct, determining the prediction category as a final category of the to-be-identified target object; and outputting the final category of the to-be-identified target object.

In some implementations, determining whether the prediction category is correct according to the hidden layer feature of the to-be-identified target object includes: inputting the hidden layer feature for the to-be-identified target object into an authenticity identification model corresponding to the prediction category, such that the authenticity identification model outputs a probability value, wherein the authenticity identification model corresponding to the prediction category reflects distribution of hidden layer features for target objects belonging to the prediction category, and the probability value represents a probability that a final category of the to-be-identified target object is the prediction category; determining that the prediction category is incorrect when the probability value is less than a probability threshold; and determining that the prediction category is correct when the probability value is greater than or equal to the probability threshold.

In some implementations, the target image comprises multiple stacked to-be-identified target objects; performing classification on the to-be-identified target object in the target image to determine the prediction category of the to-be-identified target object comprises: adjusting a height of the target image to a preset height, wherein the target image is obtained by cropping, according to a bounding box of the multiple stacked to-be-identified target objects in an acquired image, the acquired image, and a height direction of the target image is a stacking direction of the multiple stacked to-be-identified target objects; and performing classification on the to-be-identified target object in the adjusted target image to determine the prediction category of the to-be-identified target object.

In some implementations, adjusting the height of the target image to the preset height includes: scaling the height and a width of the target image in equal proportions, until the width of the target image reaches a preset width; and when the width of the scaled target image reaches the preset width, and the height of the scaled target image is greater than the preset height, reducing the height and the width of the scaled target image in equal proportions, until the height of the reduced target image is equal to the preset height.

In some implementations, adjusting the height of the target image to the preset height includes: scaling the height and a width of the target image in equal proportions, until the width of the target image reaches a preset width; and when the width of the scaled target image reaches the preset width, and the height of the scaled target image is less than the preset height, filling the scaled target image with a first pixel, such that the height of the filled scaled target image is equal to the preset height.

In some implementations, performing classification on the to-be-identified target object in the adjusted target image to determine the prediction category of the to-be-identified target object includes: performing feature extraction on the adjusted target image to obtain a feature map, wherein a height dimension of the feature map corresponds to the height direction of the target image; performing average pooling on the feature map in a width dimension of the feature map to obtain a pooled feature map; segmenting the pooled feature map in the height dimension to obtain a preset number of features; and determining the prediction category of each of the multiple stacked to-be-identified target objects according to each of the features.

In some implementations, performing classification on the to-be-identified target object in the adjusted target image to determine the prediction category of the to-be-identified target object is executed by a neural network which comprises a classification network; wherein the classification network comprises K classifiers, K being a number of known categories when classifying, K being a positive integer; and determining the prediction category of each of the multiple stacked to-be-identified target objects according to each of the features comprises: respectively calculating cosine similarities between each of the features and a weight vector of each of the K classifiers; and determining the prediction category of each of the multiple stacked to-be-identified target objects according to the calculated cosine similarities.

In some implementations, performing classification on the to-be-identified target object in the adjusted target image to determine the prediction category of the to-be-identified target object is executed by a neural network which comprises a feature extraction network, wherein the feature extraction network comprises multiple convolutional layers, respective stride of the last N convolutional layers of the multiple convolutional layers in the feature extraction network is 1 in the height dimension of the feature map, and N is a positive integer.

In some implementations, performing classification on the to-be-identified target object in the target image is executed by a neural network; the authenticity identification model corresponding to the prediction category is created by using hidden layer features for authenticated target objects belonging to the prediction category; and the authenticated target objects are correctly predicted in a training stage and/or test stage of the neural network.

Another aspect of the present disclosure features a target object identification apparatus, including: a classification unit configured to perform classification on a to-be-identified target object in a target image to determine a prediction category of the to-be-identified target object; a determination unit configured to determine whether the prediction category is correct according to a hidden layer feature for the to-be-identified target object; and a prompt unit configured to output prompt information in response to the prediction category being incorrect.

In some implementations, the apparatus further includes: an output unit configured to in response to the prediction category being correct, determine the prediction category as a final category of the to-be-identified target object; and output the final category of the to-be-identified target object.

In some implementations, the determination unit is configured to: input the hidden layer feature for the to-be-identified target object into an authenticity identification model corresponding to the prediction category, such that the authenticity identification model outputs a probability value, wherein the authenticity identification model corresponding to the prediction category reflects distribution of hidden layer features for target objects belonging to the prediction category, and the probability value represents a probability that a final category of the to-be-identified target object is the prediction category; determine that the prediction category is incorrect when the probability value is less than a probability threshold; and determine that the prediction category is correct when the probability value is greater than or equal to the probability threshold.

In some implementations, the target image comprises multiple stacked to-be-identified target objects; the classification unit is configured to: adjust a height of the target image to a preset height, wherein the target image is obtained by cropping, according to a bounding box of the multiple stacked to-be-identified target objects in an acquired image, the acquired image, and a height direction of the target image is a stacking direction of the multiple stacked to-be-identified target objects; and perform classification on the to-be-identified target object in the adjusted target image to determine the prediction category of the to-be-identified target object.

In some implementations, the classification unit is configured to: scale the height and a width of the target image in equal proportions, until the width of the target image reaches a preset width; and when the width of the scaled target image reaches the preset width, and the height of the scaled target image is greater than the preset height, reduce the height and the width of the scaled target image in equal proportions, until the height of the reduced target image is equal to the preset height.

In some implementations, the classification unit is configured to: scale the height and a width of the target image in equal proportions, until the width of the target image reaches a preset width; and when the width of the scaled target image reaches the preset width, and the height of the scaled target image is less than the preset height, fill the scaled target image with a first pixel, such that the height of the filled scaled target image is equal to the preset height.

In some implementations, the classification unit is configured to: perform feature extraction on the adjusted target image to obtain a feature map, wherein a height dimension of the feature map corresponds to the height direction of the target image; perform average pooling on the feature map in a width dimension of the feature map to obtain a pooled feature map; segment the pooled feature map in the height dimension to obtain a preset number of features; and determine the prediction category of each of the multiple stacked to-be-identified target objects according to each of the features.

In some implementations, performing classification on the to-be-identified target object in the adjusted target image to determine the prediction category of the to-be-identified target object is executed by a neural network which comprises a classification network; wherein the classification network comprises K classifiers, K being a number of known categories when classifying, K being a positive integer; and determining the prediction category of each of the multiple stacked to-be-identified target objects according to each of the features comprises: respectively calculating cosine similarities between each of the features and a weight vector of each of the K classifiers; and determining the prediction category of each of the multiple stacked to-be-identified target objects according to the calculated cosine similarities.

In some implementations, performing classification on the to-be-identified target object in the adjusted target image to determine the prediction category of the to-be-identified target object is executed by a neural network which comprises a feature extraction network, wherein the feature extraction network comprises multiple convolutional layers, respective stride of the last N convolutional layers of the multiple convolutional layers in the feature extraction network is 1 in the height dimension of the feature map, and N is a positive integer.

In some implementations, performing classification on the to-be-identified target object in the target image is executed by a neural network; the authenticity identification model corresponding to the prediction category is created by using hidden layer features for authenticated target objects belonging to the prediction category; and the authenticated target objects are correctly predicted in a training stage and/or test stage of the neural network.

Another aspect of the present disclosure features an electronic device, including a memory and a processor, where the memory is configured to store computer instructions running on the processor, and when the processor execute the computer instructions, the target object identification method according to any of the implementations of the present disclosure is implemented.

Another aspect of the present disclosure features a computer-readable storage medium having a computer program stored thereon, where when the computer program is executed by a processor, the target object identification method according to any of the implementations of the present disclosure is implemented.

Another aspect of the present disclosure features a computer program stored on a computer-readable storage medium, where when the computer program is executed by a processor, the target object identification method according to any of the implementations of the present disclosure is implemented.

According to the target object identification system, method and apparatus, the device, and the storage medium provided in one or more embodiments of the present disclosure, classification is performed on the to-be-identified target object in the target image to determine the prediction category of the to-be-identified target object, that is, which one of the known categories the to-be-identified target object belongs to is determined; and whether the prediction category is correct is determined according to the hidden layer feature for the to-be-identified target object, and prompt information is output if the prediction category is incorrect, so that target object that does not belong to any of the known categories, i.e., the target object that does not belong to a current scene, may be identified, and prompt may be given.

It should be understood that the above general description and the following detailed description are merely exemplary and explanatory, and are not intended to limit the present disclosure.

### BRIEF DESCRIPTION OF THE DRAWINGS

The accompanying drawings herein incorporated in the description and constituting a part of the description describe the embodiments of the present disclosure and are intended to explain the technical solutions of the present disclosure together with the description.

FIG. 1 is a flowchart of a target object identification method provided in at least one embodiment of the present disclosure;

FIGS. 2A and 2B are schematic diagrams of multiple target objects in a target object identification method provided in at least one embodiment of the present disclosure, respectively;

FIG. 3 is a flowchart of a method for performing classification on a to-be-identified target object in a target image provided in at least one embodiment of the present disclosure;

FIG. 4 shows a schematic diagram of a neural network training process;

FIG. 5 is a schematic structural diagram of a target object identification apparatus provided in at least one embodiment of the present disclosure; and

FIG. 6 is a schematic structural diagram of an electronic device provided in at least one embodiment of the present disclosure.

### DETAILED DESCRIPTION OF THE EMBODIMENTS

To make a person skilled in the art better understand the technical solutions in one or more embodiments of the description, the technical solutions in the one or more embodiments of the description are clearly and fully described below with reference to the accompanying drawings in the one or more embodiments of the description. Apparently, the described embodiments are merely some of the embodiments of the description, rather than all the embodiments. Based on the one or more embodiments of the description, all other embodiments obtained by a person of ordinary skill in the art without involving an inventive effort shall fall within the scope of protection of the present disclosure.

Terms used in the present disclosure are for the purpose of describing particular embodiments only and are not intended to limit the present disclosure. The singular form “a/an”, “said”, and “the” used in the present disclosure and the attached claims are also intended to include the plural form, unless other meanings are clearly represented in the context. It should also be understood that the term “and/or” used herein refers to and includes any or all possible combinations of one or more associated listed terms. In addition, the term “at least one” herein represents any one of multiple types or any combination of at least two of multiple types.

It should be understood that although the present disclosure may use the terms such as first, second, and third to describe various information, the information should not be limited to these terms. These terms are only used to distinguish the same type of information from one another. For example, in the case of not departing from the scope of the present disclosure, first information may also be referred to as second information; similarly, the second information may also be referred to as the first information. Depending on the context, for example, the word “if” used herein may be interpreted as “upon” or “when” or “in response to determining”.

To make a person skilled in the art better understand the technical solutions in the embodiments of the present disclosure, and to enable the aforementioned purposes, features, and advantages of the embodiments of the present disclosure to be more obvious and understandable, the technical solutions in the embodiments of the present disclosure are further explained in detail below by combining the accompanying drawings.

FIG. 1 is a flowchart of a target object identification method provided by at least one embodiment of the present disclosure. As shown in FIG. 1, the method may include steps 101 to 103.

In step 101, classification is performed on a to-be-identified target object in a target image to determine a prediction category of the to-be-identified target object.

In some examples, the to-be-identified target objects may include sheet-shaped objects of various shapes, for example, game coins. A to-be-identified target object may be a single target object, or may be one or more of multiple target objects stacked together. Each target object stacked together generally has the same thickness (height).

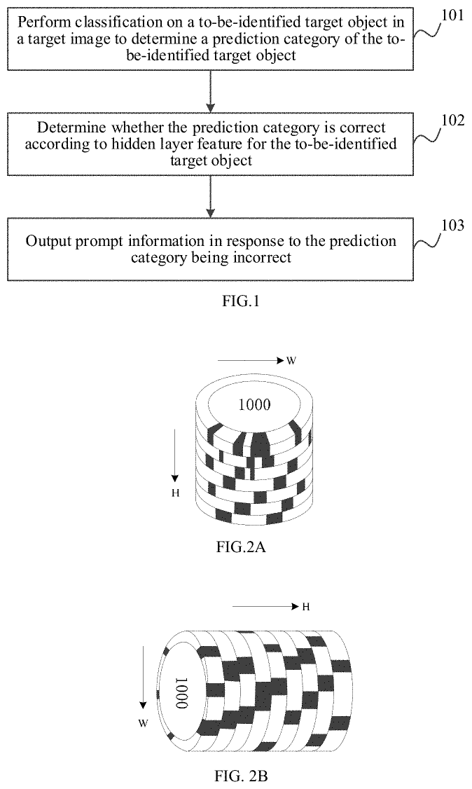

The multiple to-be-identified target objects included in the target image are usually stacked in the thickness direction. As shown in FIG. 2A, multiple game coins are stacked in the vertical direction (stacked in a stand mode), the height direction (H) of the target image is the vertical direction, and the width direction (W) of the target image is a direction perpendicular to the height direction (H) of the target image. As also shown in FIG. 2B, multiple game coins are stacked in the horizontal direction (stacked in a float mode), the height direction (H) of the target image is the horizontal direction, and the width direction (W) of the target image is a direction perpendicular to the height direction (H) of the target image.

In the embodiments of the present disclosure, a classification network, such as a Convolutional Neural Network (CNN) may be utilized to perform classification on the to-be-identified target object to determine the prediction category of the to-be-identified target object. The classification network may include K classifiers, where K is a number of known categories when classifying, and K is a positive integer. By performing classification on the to-be-identified target object, it may be determined which one of the known categories the to-be-identified target object belongs to. It should be noted that since the classification network determines the probability of the to-be-identified target object belonging to each known category according to feature information (a hidden layer feature) of the to-be-identified target object, and determines the category with the highest probability as the prediction category to which the to-be-identified target object belongs, even for a to-be-identified target object that does not belong to any of the known categories, the classification network would always output one of the known categories as the classification result, i.e., the prediction category.

In step 102, whether the prediction category is correct is determined according to a hidden layer feature for the to-be-identified target object.

In specific implementations, an authenticity identification model corresponding to the prediction category may be utilized to determine, according to the hidden layer feature for the to-be-identified target object, whether the prediction category is correct, where an authenticity identification model corresponding to one prediction category reflects distribution of hidden layer features for target objects belonging to the prediction category. Since the authenticity identification model reflects the distribution of the hidden layer features for the target objects belonging to the same category, whether the prediction category is correct may be determined. The authenticity identification model may be a probability distribution model created according to the hidden layer features for the target objects belonging to the same category.

In a specific implementation process, the authenticity identification model may include a Gaussian probability distribution model, or another model that may reflect the distribution of hidden layer features for the target objects belonging to the same category.

For a hidden layer feature input to the authenticity identification model corresponding to one prediction category, the authenticity identification model may output a probability value of the input hidden layer feature belonging to hidden layer features for target objects belonging to the prediction category, so as to determine whether the input hidden layer feature belongs to the hidden layer features for the target objects belonging to the prediction category. If the probability value is greater than or equal to a probability threshold, it is determined that the prediction category determined in step 101 is correct, and if the probability value is less than the probability threshold, it is determined that the prediction category determined in step 101 is incorrect. That is to say, a true category of the to-be-identified target object does not belong to the known categories when classifying in step 101, but is an unknown category. The hidden layer feature for the target object refers to a feature before inputting to classifiers in the classification network when performing classification on the target object using the classification network.

In step 103, prompt information is output in response to the prediction category being incorrect.

In the embodiments of the present disclosure, for K known categories, K authenticity identification models may be created. The K categories may be all categories of target objects in the current scene. Target objects other than those of the K categories may be considered as objects that do not belong to the current scene, or are called foreign objects, and the categories thereof are unknown categories.

The to-be-identified target object with incorrect prediction category indicates that the to-be-identified target object does not actually belong to any of the known categories, but belongs to an unknown category. That is, it can be determined that the to-be-identified target object do not belong to the current scene, but is a foreign object.

In an example, in response to the prediction category being incorrect, that is, the to-be-identified target object is a foreign object, prompt information of “unknown category” may be output.

In some embodiments, classification is performed on the to-be-identified target object in the target image to determine the prediction category of the to-be-identified target object, that is, which one of the known categories the to-be-identified target object belong to is determined; and since the authenticity identification model reflects the distribution of hidden layer features for target objects belonging to the same category, whether the prediction category is correct may be determined by using the authenticity identification model corresponding to the prediction category according to the hidden layer feature for the to-be-identified target object, and prompt information is output if the prediction category is incorrect, so as to identify the target object that does not belong to any of the known categories, that is, not belong to the current scene, and a prompt is given.

In the case that the target image includes multiple to-be-identified target objects, if one of the multiple to-be-identified target objects is a target object of an unknown category, prompt information may be output to prompt relevant personnel about that the target object of unknown category is incorporated into the multiple to-be-identified target objects.

If the prediction category of the to-be-identified target object is correct, the prediction category can be determined as a final category of the to-be-identified target object and the final category of the to-be-identified target object can be output.

In some embodiments, it may be determined whether the prediction category determined in step 101 is correct in the following manner.

The hidden layer feature for the to-be-identified target object is input to the authenticity identification model corresponding to the prediction category, such that the authenticity identification model corresponding to the prediction category outputs a probability value, where the probability value represents a probability that a final category of the to-be-identified target object is the prediction category. If the probability value is less than a probability threshold, it is determined that the prediction category is incorrect; and if the probability value is greater than or equal to the probability threshold, it is determined that the prediction category is correct.

Since the authenticity identification model reflects the distribution of hidden layer features for the target objects belonging to the same category, the authentication identification model corresponding to the prediction category is utilized to determine the probability that the input hidden layer feature for the to-be-identified target object belongs to the hidden layer features for the target objects belonging to the prediction category. If the probability value output by the authenticity identification model is less than the probability threshold, it can be determined that the input hidden layer feature for the to-be-identified target object does not belong to the hidden layer features for the target objects belonging to the prediction category, and thus it can be determined that the prediction category determined in step 101 is incorrect; on the contrary, if the probability value output by the authenticity identification model is greater than or equal to the probability threshold, it can be determined that the input hidden layer feature for the to-be-identified target object belongs to the hidden layer features for the target objects belonging to the prediction category, and thus it can be determined that the prediction category determined in step 101 is correct.

In some embodiments, classification may be performed on the to-be-identified target object by the following manner.

First, a target image is obtained. The target image is cropped from an acquired image according to a bounding box of multiple target objects stacked in the acquired image, and a height direction of the target image is the stacking direction of the multiple target objects. The to-be-identified target object may be one or more of the multiple target objects stacked together. For example, the to-be-identified target object is all of the multiple target objects stacked in the stand mode in the vertical direction as shown in FIG. 2A, or one of the multiple target objects stacked in the float mode in the horizontal direction as shown in FIG. 2B.

A target image (referred to as a side view image) including multiple standing target objects may be photographed by an image acquisition apparatus provided on the side of a target area, or a target image (referred to as a top view image) including multiple floating target objects may be photographed by an image acquisition apparatus provided above the target area.

Next, the height of the target image is adjusted to a preset height, and classification is performed on the to-be-identified target object in the adjusted target image to determine a prediction category of the to-be-identified target object.

In the embodiments of the present disclosure, adjusting the height of the target image to a uniform height facilitates processing the hidden layer feature and improving the identification accuracy of the target object.

In some embodiments, the height of the target image may be adjusted to the preset height in the following manner.

First, a preset height and a preset width corresponding to the target image are obtained to perform size transformation on the target image. The preset width may be set according to an average width of the target objects, and the preset height may be set according to an average height of the target objects and the maximum number of to-be-identified target objects.

In an example, the height and a width of the target image may be scaled in an equal proportion, until the width of the target image reaches the preset width. Scaling the target image in the equal proportion refers to enlarging or reducing the target image while maintaining the ratio of the height to the width of the target image unchanged. The unit of the preset width and the preset height may be pixel or other units, and is not limited in the present disclosure.

If the width of the scaled target image reaches the preset width, and the height of the scaled target image is greater than the preset height, the height and the width of the scaled target image are reduced in the equal proportion, until the height of the reduced target image is equal to the preset height.

For example, assuming that the target objects are game coins, the preset width may be set to 224 pix (pixels) according to the average width of the game coins; and the preset height may be set to 1344 pix according to the average height of the game coins and the maximum number of game coins to be identified, for example, 72. First, the width of the target image may be adjusted to 224 pix, while the height of the target image may be adjusted in an equal proportion. If the adjusted height is greater than 1344 pix, the height of the adjusted target image may be adjusted again so that the height of the target image is 1344 pix, while the width of the target image is adjusted in the equal proportion, so that the height of the target image is adjusted to the preset height of 1344 pix. If the adjusted height is equal to 1344 pix, there is no need to adjust again, that is, the height of the target image has been adjusted to the preset height of 1344 pix.

In an example, the height and the width of the target image are scaled in the equal proportion, until the width of the target image reaches the preset width; and if the width of the scaled target image reaches the preset width, and the height of the scaled target image is less than the preset height, the scaled target image is filled with a first pixel, so that the height of the filled scaled target image is the preset height.

The first pixel may be a pixel with a pixel value of (127, 127, 127), that is, a gray pixel. The first pixel may also be set to other pixel values, and the specific pixel value does not affect the effect of the embodiments of the present disclosure.

Still taking the game coins as the target objects, the preset width being 224 pix, the preset height being 1344 pix, and the maximum number being 72 as an example, first, the width of the target image may be adjusted to 224 pix, while the height of the target image may be adjusted in the equal proportion. If the adjusted height is less than 1344 pix, the portion with the height less than 1344 pix is filled with a gray pixel, so that the height of the filled target image is 1344 pix. If the adjusted height is equal to 1344 pix, there is no need to perform filling, that is, the height of the target image has been adjusted to the preset height of 1344 pix.

After the height of the target image is adjusted to the preset height, classification may be performed on the to-be-identified target object in the adjusted target image.

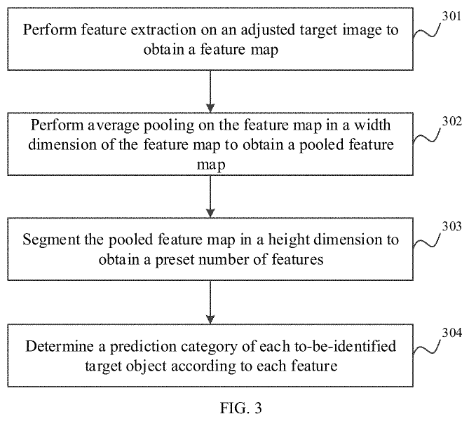

FIG. 3 shows a flowchart of a method for performing classification on a to-be-identified target object in a target image provided by at least one embodiment of the present disclosure. As shown in FIG. 3, the method includes steps 301 to 304.

In step 301, feature extraction is performed on the adjusted target image to obtain a feature map.

In an example, the obtained feature map may include multiple dimensions, such as channel dimension, height dimension, width dimension, and batch dimension, and the format of the feature map may be expressed as, for example, [B C H W], where B represents the batch dimension, C represents the channel dimension, H represents the height dimension, and W represents the width dimension. The height dimension of the feature map corresponds to the height direction of the target image, and the width dimension corresponds to the width direction of the target image.

In step 302, average pooling is performed on the feature map in the width dimension of the feature map to obtain a pooled feature map.

By performing average pooling on the feature map in the width dimension, the height dimension and the channel dimension are kept unchanged, to obtain the pooled feature map.

For example, when the feature map is 2048*72*8 (the channel dimension is 2048, the height is 72, and the width is 8), after performing average pooling in the width dimension, a feature map of 2048*72*1 is obtained.

In step 303, the pooled feature map is segmented in the height dimension to obtain a preset number of features.

By segmenting the pooled feature map in the height dimension, the preset number of features may be obtained, where each feature may be considered to correspond to a target object. The preset number is the maximum number of target objects to be identified.

For example, the maximum number is 72, and the pooled feature map in the example above is segmented in the height dimension, that is, the feature map of 2048*72*1 is split in the height dimension to obtain 72 2048-dimensional vectors, and each vector corresponds to the feature corresponding to 1/72 area in the height direction in the target image. One feature can be represented by a 2048-dimensional vector.

In step 304, the prediction category of each to-be-identified target object is determined according to each feature.

In embodiments of the present disclosure, if the height of the adjusted target image is less than the preset height, the adjusted target image is filled so that the height reaches the preset height. If the height of the adjusted target image is greater than the preset height, the height of the adjusted target image is reduced to the preset height while the width of the adjusted target image is reduced in an equal proportion. Therefore, the feature map of the target image is obtained according to the target image having the preset height. Moreover, since the preset height is set according to the maximum number of to-be-identified target objects, the feature map is segmented according to the maximum number, each obtained segmented feature (may also be referred to as feature) corresponds to one target object, and the target objects are identified according to each segmented feature, the influence of the number of target objects can be reduced and the accuracy of the identification of each target object can be improved. Moreover, since the number of target objects included in the target image may be different in different identification processes, the difference in the height-to-width ratio of the target image may be relatively large. By maintaining the height-to-width ratio to adjust the target image, image deformation is reduced, and the identification accuracy can be further improved.

In some embodiments, when classification is performed on features corresponding to the portion filled with the first pixel, such as, the gray pixel, in the filled target image, the classification results are empty. According to the number of non-empty classification results obtained, the number of target objects included in the target image may be determined.

Assuming that the maximum number of to-be-identified target objects is 72, the feature map of the adjusted target image is divided or segmented into 72 segments, and the target objects are identified according to each segmented feature, 72 classification results may be obtained. If the target image includes a gray pixel filled area, the classification results of the target objects corresponding to features of the gray pixel filled area are empty. For example, when 16 empty classification results are obtained, 56 non-empty classification results are obtained, and thus it can be determined that the target image includes 56 target objects.

A person skilled in the art should understand that the aforementioned preset width, preset height, and the maximum number of to-be-identified target objects are all examples, specific values of these parameters may be specifically set according to actual needs, and are not limited in the embodiments of the present disclosure.

In some embodiments, performing classification on the to-be-identified target object in the adjusted target image to determine the prediction category of the to-be-identified target object is performed by a neural network which includes a classification network; the classification network includes K classifiers, where K is a number of known categories when classifying, and K is a positive integer.

The neural network may determine the prediction category of each to-be-identified target object according to each feature obtained by segmenting the pooled feature map in the height dimension.

First, the cosine similarities between each feature and the weight vector of each classifier are respectively calculated.

In an example, before calculating the cosine similarity, the weight vector of each classifier may be normalized, and each feature input to the classifiers may be normalized to improve the classification accuracy of the neural network.

Next, the prediction category of each of multiple to-be-identified target objects is determined according to the calculated cosine similarities.

For each feature, the cosine similarity between the feature and the weight vector of each classifier is calculated, and the category of the classifier with the maximum cosine similarity is used as the prediction category of the to-be-identified target object corresponding to the feature.

By determining the prediction category of the to-be-identified target object corresponding to each feature according to the cosine similarities of each feature and the weight vector of each classifier, the classification effect of the classification network may be improved.

In some embodiments, the neural network includes a feature extraction network. The feature extraction network may include multiple convolutional layers, or the feature extraction network may include multiple convolutional layers and multiple pooling layers, etc. After multilayer feature extraction is performed, the low-level layer features may be gradually converted into middle- or high-level features to improve the expressive power of the target image and facilitate subsequent processing.

In an example, the last N convolutional layers of the feature extraction network respectively have a stride of 1 in the height dimension of the feature map, so as to retain as many features in the height dimension as possible. N is a positive integer.

Taking the feature extraction network as a Residual Network (ResNet) including four residual units as an example, in the related art, the stride of the last convolutional layers in the third and fourth residual units in the residual network is usually (2, 2). In the embodiments of the present disclosure, the stride (2, 2) may be changed to (1, 2), so that down-sampling is not performed on the height dimension of the feature map, but down-sampling is performed on the width dimension of the feature map, so as to retain as many features in the height dimension as possible.

In some embodiments, other preprocessing may be performed on the target image, for example, a normalized operation, etc., is performed on the pixel values of the target image.

In the embodiments of the present disclosure, the method further includes training a neural network, where the neural network includes a feature extraction network configured to perform feature extraction on the adjusted target image and a classification network configured to perform classification on the to-be-identified target object in the target image.

FIG. 4 shows a schematic diagram of the training process of a neural network. As shown in FIG. 4, for the training process of the neural network, the utilized modules include a preprocessing module 401, an image enhancement module 402, and a feature segmentation module 404. The neural network 403 includes a feature extraction network 4031 and a classification network 4032.

In the embodiments of the present disclosure, the neural network is trained by using sample images and annotation results thereof

In an example, the annotation result of the sample image includes the annotation category of each target object in the sample image. Taking the game coins as an example, the category of each game coin is related to the denomination, and the game coins of the same denomination belong to the same category. For a sample image including multiple game coins stacked in the stand mode, the denomination of each game coin is annotated in the sample image.

Taking the processing process of a sample image 400 shown in FIG. 4 as an example, the training process of a neural network is described, where the sample image 400 includes multiple stacked game coins, and the denomination of each game coin is annotated in the sample image 400, that is, the true category of each game coin is annotated.

First, preprocessing is performed on the sample image 400 by means of the preprocessing module 401. The preprocessing includes: adjusting the size of the sample image 400 while maintaining the height-to-width ratio, and performing a normalized operation on the pixel values of the sample image 400, etc. The specific process of adjusting the size of the sample image 400 while maintaining the height-to-width ratio is as described above.

After preprocessing, the image enhancement module 402 may also be utilized to perform image enhancement on the preprocessed sample image. Performing image enhancement on the preprocessed sample image includes: performing operations such as random flipping, random cropping, random height-to-width ratio fine tuning, and random rotating on the preprocessed sample image, to obtain an enhanced sample image. The enhanced sample image can be used in the training stage of the neural network, so as to improve the robustness of the neural network.

For the enhanced sample image, the feature extraction network 4031 is utilized to obtain a feature map of multiple target objects included in the enhanced sample image. The specific structure of the feature extraction network 4031 is as described above.

Then, the feature segmentation module 404 is utilized to segment the feature map in the height dimension to obtain a preset number of features.

Next, the classification network 4032 is utilized to determine the prediction category of each to-be-identified target object according to each feature.

Parameters of the neural network 403, including parameters of the feature extraction network 4031 and parameters of the classification network 4032, are adjusted according to a difference between the prediction category of the to-be-identified target object and the annotation category of the to-be-identified target object.

In some embodiments, a loss function for training the neural network includes Connectionist Temporal Classification (CTC for short) loss function, that is, the parameters of the neural network may be updated by performing back propagation according to the CTC loss function.

In some embodiments, a test image and its annotation result may also be used to test a trained neural network, where the annotation result of the test image also includes the annotation category of each to-be-identified target object in the test image. The test process of the neural network is similar to the forward propagation process in the training process, except that image enhancement processing is not performed. For details, please refer to the process shown in FIG. 4. In the test stage, the prediction category of the to-be-identified target object in the test image is obtained according to the input test image.

In some embodiments, an authenticity identification model corresponding to one category is created by using hidden layer features for authenticated target objects belonging to the category. The authenticated target objects are correctly predicted in the training stage and/or test stage of the neural network. Correct prediction refers to that in the training stage and/or test stage, the prediction category of the authenticated target object obtained by the neural network is the same as the annotation result of the authenticated target object.

For example, during the training and test stages, n game coins belonging to the i-th category are correctly predicted, and according to the processing of the neural network shown in FIG. 4, hidden layer features corresponding to the n game coins may be obtained, and the authenticity identification model corresponding to the i-th category, such as a Gaussian probability distribution model, may be created by using each hidden layer feature for the n game coins. i=1, 2, . . . , M, and M is a positive integer. n is a positive integer.

For the obtained authenticity identification model corresponding to the i-th category, the hidden layer feature for the to-be-identified target object obtained with the neural network shown in FIG. 4 are input to the authenticity identification model, so that the probability value that the hidden layer feature for the to-be-identified target object belong to the hidden layer features belonging the i-th category may be obtained. When the probability value is less than a probability threshold, it indicates that the to-be-identified target object is a foreign object.

In the embodiments of the present disclosure, the hidden layer features for authenticated target objects belonging to a category are utilized to create an authenticity identification model corresponding to the category, so as to establish a basis for determining whether the input hidden layer feature is included in the hidden layer features for the targets object belonging to the category, that is, to establish a basis for determining whether a to-be-identified target object is a target object of an unknown category, thereby improving the identification accuracy of the to-be-identified target object.

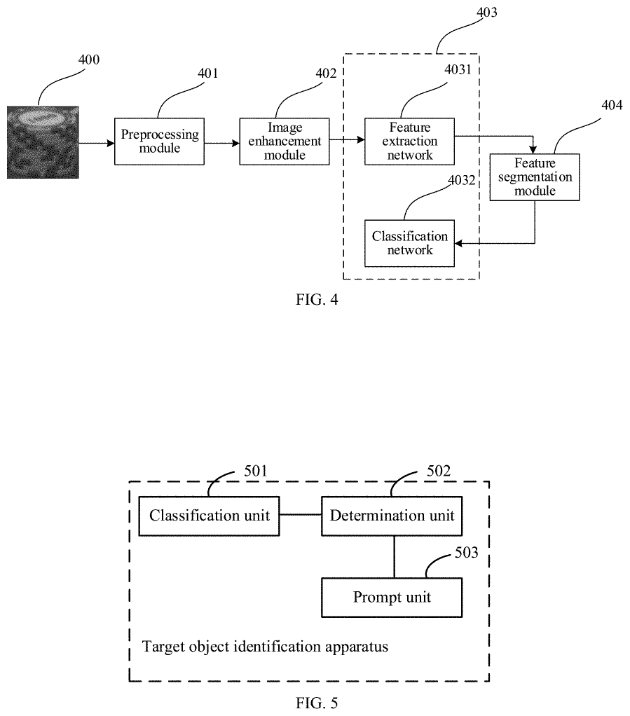

FIG. 5 is a schematic structural diagram of a target object identification apparatus provided by at least one embodiment of the present disclosure. As shown in FIG. 5, the apparatus includes: a classification unit 501 configured to perform classification on a to-be-identified target object in a target image to determine a prediction category of the to-be-identified target object; a determination unit 502 configured to determine whether the prediction category is correct according to a hidden layer feature for the to-be-identified target object; and a prompt unit 503 configured to output prompt information in response to the prediction category being incorrect.

In some embodiments, the apparatus further includes an output unit configured to: in response to the prediction category being correct, determine the prediction category as a final category of the to-be-identified target object; and output the final category of the to-be-identified target object.

In some embodiments, the determination unit is specifically configured to: input the hidden layer feature for the to-be-identified target object into an authenticity identification model corresponding to the prediction category, such that the authenticity identification model outputs a probability value, wherein the authenticity identification model corresponding to the prediction category reflects distribution of hidden layer features for target objects belonging to the prediction category, and the probability value represents a probability that a final category of the to-be-identified target object is the prediction category; determine that the prediction category is incorrect when the probability value is less than a probability threshold; and determine that the prediction category is correct when the probability value is greater than or equal to the probability threshold.

In some embodiments, the target image comprises multiple stacked to-be-identified target objects; the classification unit is configured to: adjust a height of the target image to a preset height, wherein the target image is obtained by cropping, according to a bounding box of the multiple stacked to-be-identified target objects in an acquired image, the acquired image, and a height direction of the target image is a stacking direction of the multiple stacked to-be-identified target objects; and perform classification on the to-be-identified target object in the adjusted target image to determine the prediction category of the to-be-identified target object.

In some embodiments, the classification unit is specifically configured to: scale the height and a width of the target image in equal proportions, until the width of the target image reaches a preset width; and when the width of the scaled target image reaches the preset width, and the height of the scaled target image is greater than the preset height, reduce the height and the width of the scaled target image in equal proportions, until the height of the reduced target image is equal to the preset height.

In some embodiments, the classification unit is specifically configured to: scale the height and the width of the target image in equal proportions, until the width of the target image reaches a preset width; and when the width of the scaled target image reaches the preset width, and the height of the scaled target image is less than the preset height, fill the scaled target image with a first pixel, so that the height of the filled scaled target image is equal to the preset height.

In some embodiments, the classification unit is specifically configured to: perform feature extraction on the adjusted target image to obtain a feature map, where a height dimension of the feature map corresponds to the height direction of the target image; perform average pooling on the feature map in a width dimension of the feature map to obtain a pooled feature map; segment the pooled feature map in the height dimension to obtain a preset number of features; and determine the prediction category of each of the multiple stacked to-be-identified target objects according to each of the features.

In some embodiments, performing classification on the to-be-identified target object in the adjusted target image to determine the prediction category of the to-be-identified target object is executed by a neural network which comprises a classification network; wherein the classification network comprises K classifiers, K being a number of known categories when classifying, K being a positive integer; and determining the prediction category of each of the multiple stacked to-be-identified target objects according to each of the features comprises: respectively calculating cosine similarities between each of the features and a weight vector of each of the K classifiers; and determining the prediction category of each of the multiple stacked to-be-identified target objects according to the calculated cosine similarities.

In some embodiments, performing classification on the to-be-identified target object in the adjusted target image to determine the prediction category of the to-be-identified target object is executed by a neural network which includes a feature extraction network, where the feature extraction network includes multiple convolutional layers, respective stride of the last N convolutional layers of the multiple convolutional layers in the feature extraction network is 1 in the height dimension of the feature map, and N is a positive integer.

In some embodiments, performing classification on the to-be-identified target object in the target image is executed by a neural network; the authenticity identification model corresponding to the prediction category is created by using hidden layer features for authenticated target objects belonging to the prediction category; and the authenticated target objects are correctly predicted in a training stage and/or test stage of the neural network.

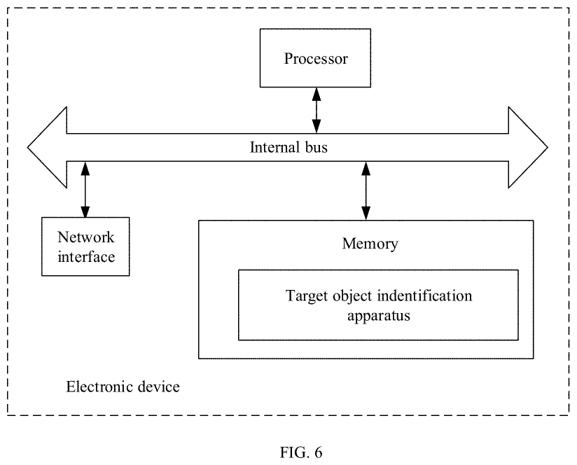

The embodiments of the apparatus of the present disclosure may be applied to an electronic device, for example, a server or a terminal device. The apparatus embodiments may be implemented by software, or by hardware or a combination of hardware and software. Taking implementation by software as an example, as an apparatus in a logical sense, the apparatus is formed by reading corresponding computer program instructions in a non-volatile memory into a memory with a processor. In terms of hardware, as shown in FIG. 6, which is a structural diagram of hardware for an electronic device where the target object identification apparatus is located, in addition to a processor, a memory, a network interface, and a non-volatile memory shown in FIG. 6, in the embodiments, the electronic device may further include other hardware according to the actual functions of the electronic device. Details are not described below again.

Accordingly, the embodiments of the present disclosure further provide a computer-readable storage medium having a computer program stored thereon, and when the program is executed by a processor, the method according to any one of the embodiments is implemented.

Accordingly, the embodiments of the present disclosure further provide a computer program stored on a computer-readable storage medium, where when the computer program is executed by a processor, the target object identification method according to any of the embodiments of the present disclosure is implemented.

Accordingly, the embodiments of the present disclosure further provide an electronic device. As shown in FIG. 6, the electronic device includes a memory, a processor, and a computer program stored on the memory and running on the processor, where when the computer program is executed by the processor, the method according to any one of the embodiments is implemented.

In the present disclosure, the form of a computer program product implemented over one or more storage media (including but not limited to a disk memory, a CD-ROM (Compact Disc Read-Only Memory), an optical memory, etc.) that include a program code may be used. A computer usable storage medium includes permanent and non-permanent, movable and non-movable media, and information storage may be implemented by means of any method or technique. Information may be computer readable commands, data structures, program modules, or other data. Examples of the storage medium of the computer include, but not limited to: a Phase Change Access Memory (PRAM), a Static Random Access Memory (SRAM), a Dynamic Random Access Memory (DRAM), other types of Random Access Memories (RAM), a Read-Only Memory (ROM), an Electrically Erasable Programmable Read-Only Memory (EEPROM), a flash memory, or other memory techniques, a CD-ROM, a Digital Versatile Disc (DVD), or other optical storages, a magnetic box typed cassette, a magnetic cassette magnetic disk, or other magnetic storage devices, or any other non-transmission media, which may be used for storing information accessible by the computer device.

A person skilled in the art could easily conceive of other implementations of the present disclosure after considering the description and practicing the description disclosed herein. The present disclosure is intended to cover any variations, applications, or adaptive changes of the present disclosure. These variations, applications, or adaptive changes comply with general principles of the present disclosure, and include common general knowledge or common technical means in the technical field that are not disclosed in the present disclosure. The description and embodiments are merely considered to be exemplary, and the actual scope and spirit of the present disclosure are pointed out in the following claims.

It should be understood that the present disclosure does not limit at an accurate structure that is described above and shown in the drawings, and may be modified and changed in every way without departing from the scope thereof. The scope of the present disclosure is limited only by the attached claims.

The above descriptions are merely some embodiments of the present disclosure, but are not intended to limit the present disclosure. Any modification, equivalent replacement, or improvement made without departing from the spirit and principle of the present disclosure shall fall within the scope of protection of the present disclosure.

The descriptions of the embodiments above trend on differences between the embodiments, and for same or similar parts in the embodiments, reference may be made to these embodiments. For brevity, details are not described herein again.

1. A method of target object identification, the method comprising:
performing classification on a to-be-identified target object in a target image to determine a prediction category of the to-be-identified target object;
determining whether the prediction category is correct according to a hidden layer feature for the to-be-identified target object; and
outputting prompt information in response to determining that the prediction category is incorrect.

2. The method according to claim 1, further comprising:
in response to determining that the prediction category is correct, determining the prediction category as a final category of the to-be-identified target object; and
outputting the final category of the to-be-identified target object.

3. The method according to claim 1, wherein determining whether the prediction category is correct according to the hidden layer feature of the to-be-identified target object comprises:
inputting the hidden layer feature for the to-be-identified target object into an authenticity identification model corresponding to the prediction category, such that the authenticity identification model outputs a probability value, wherein the authenticity identification model corresponding to the prediction category reflects a distribution of hidden layer features for target objects belonging to the prediction category, and the probability value represents a probability that a final category of the to-be-identified target object is the prediction category;
determining that the prediction category is incorrect if the probability value is less than a probability threshold; and
determining that the prediction category is correct if the probability value is greater than or equal to the probability threshold.

4. The method according to claim 3, wherein performing classification on the to-be-identified target object in the target image is executed by a neural network,
wherein the authenticity identification model corresponding to the prediction category is created by using hidden layer features for authenticated target objects belonging to the prediction category, and
wherein the authenticated target objects are correctly predicted in at least one of a training stage or a test stage of the neural network.

5. The method according to claim 1, wherein the target image comprises multiple stacked to-be-identified target objects, and
wherein performing classification on the to-be-identified target object in the target image to determine the prediction category of the to-be-identified target object comprises:
adjusting a height of the target image to a preset height, wherein the target image is obtained by cropping an acquired image according to a bounding box of the multiple stacked to-be-identified target objects in the acquired image, and wherein a height direction of the target image is a stacking direction of the multiple stacked to-be-identified target objects; and
performing classification on the to-be-identified target object in the adjusted target image to determine the prediction category of the to-be-identified target object.

6. The method according to claim 5, wherein adjusting the height of the target image to the preset height comprises:
scaling the height and a width of the target image in equal proportions until the width of the target image reaches a preset width; and
in response to determining that the width of the scaled target image reaches the preset width and the height of the scaled target image is greater than the preset height, reducing the height and the width of the scaled target image in equal proportions until the height of the reduced target image is equal to the preset height.

7. The method according to claim 5, wherein adjusting the height of the target image to the preset height comprises:
scaling the height and a width of the target image in equal proportions until the width of the target image reaches a preset width; and
in response to determining that the width of the scaled target image reaches the preset width and the height of the scaled target image is less than the preset height, filling the scaled target image with a first pixel, such that the height of the filled scaled target image is equal to the preset height.

8. The method according to claim 5, wherein performing classification on the to-be-identified target object in the adjusted target image to determine the prediction category of the to-be-identified target object comprises:
performing feature extraction on the adjusted target image to obtain a feature map, wherein a height dimension of the feature map corresponds to the height direction of the target image;
performing average pooling on the feature map in a width dimension of the feature map to obtain a pooled feature map;
segmenting the pooled feature map in the height dimension to obtain a preset number of features; and
determining the prediction category of each of the multiple stacked to-be-identified target objects according to each of the features.

9. The method according to claim 8, wherein performing classification on the to-be-identified target object in the adjusted target image to determine the prediction category of the to-be-identified target object is executed by a neural network that comprises a classification network, wherein the classification network comprises K classifiers, K being a number of known categories when classifying, K being a positive integer; and
determining the prediction category of each of the multiple stacked to-be-identified target objects according to each of the features comprises:
respectively calculating cosine similarities between each of the features and a weight vector of each of the K classifiers; and
determining the prediction category of each of the multiple stacked to-be-identified target objects according to the calculated cosine similarities.

10. The method according to claim 8, wherein performing classification on the to-be-identified target object in the adjusted target image to determine the prediction category of the to-be-identified target object is executed by a neural network that comprises a feature extraction network, wherein the feature extraction network comprises multiple convolutional layers, and a corresponding stride of last N convolutional layers of the multiple convolutional layers in the feature extraction network is 1 in the height dimension of the feature map, N being a positive integer.

11. An electronic device, comprising:
at least one processor; and
one or more memories coupled to the at least one processor and storing programming instructions for execution by the at least one processor to perform operations comprising:
performing classification on a to-be-identified target object in a target image to determine a prediction category of the to-be-identified target object;
determining whether the prediction category is correct according to a hidden layer feature for the to-be-identified target object; and
outputting prompt information in response to determining that the prediction category is incorrect.

12. The electronic device according to claim 11, wherein the operations further comprise:
in response to determining that the prediction category is correct, determining the prediction category as a final category of the to-be-identified target object; and
outputting the final category of the to-be-identified target object.

13. The electronic device according to claim 11, wherein determining whether the prediction category is correct according to the hidden layer feature of the to-be-identified target object comprises:
inputting the hidden layer feature for the to-be-identified target object into an authenticity identification model corresponding to the prediction category, such that the authenticity identification model outputs a probability value, wherein the authenticity identification model corresponding to the prediction category reflects distribution of hidden layer features for target objects belonging to the prediction category, and the probability value represents a probability that a final category of the to-be-identified target object is the prediction category;
determining that the prediction category is incorrect if the probability value is less than a probability threshold; and
determining that the prediction category is correct if the probability value is greater than or equal to the probability threshold.

14. The electronic device according to claim 13, wherein performing classification on the to-be-identified target object in the target image is executed by a neural network,
wherein the authenticity identification model corresponding to the prediction category is created by using hidden layer features for authenticated target objects belonging to the prediction category, and
wherein the authenticated target objects are correctly predicted in at least one of a training stage or a test stage of the neural network.

15. The electronic device according to claim 11, wherein the target image comprises multiple stacked to-be-identified target objects;
performing classification on the to-be-identified target object in the target image to determine the prediction category of the to-be-identified target object comprises:
adjusting a height of the target image to a preset height, wherein the target image is obtained by cropping an acquired image according to a bounding box of the multiple stacked to-be-identified target objects in the acquired image, and wherein a height direction of the target image is a stacking direction of the multiple stacked to-be-identified target objects; and
performing classification on the to-be-identified target object in the adjusted target image to determine the prediction category of the to-be-identified target object.

16. The electronic device according to claim 15, wherein adjusting the height of the target image to the preset height comprises:
scaling the height and a width of the target image in equal proportions, until the width of the target image reaches a preset width; and
in response to determining that the width of the scaled target image reaches the preset width, and the height of the scaled target image is greater than the preset height, reducing the height and the width of the scaled target image in equal proportions, until the height of the reduced target image is equal to the preset height.

17. The electronic device according to claim 15, wherein adjusting the height of the target image to the preset height comprises:
scaling the height and a width of the target image in equal proportions, until the width of the target image reaches a preset width; and
in response to determining that the width of the scaled target image reaches the preset width, and the height of the scaled target image is less than the preset height, filling the scaled target image with a first pixel, such that the height of the filled scaled target image is equal to the preset height.

18. The electronic device according to claim 15, wherein performing classification on the to-be-identified target object in the adjusted target image to determine the prediction category of the to-be-identified target object comprises:
performing feature extraction on the adjusted target image to obtain a feature map, wherein a height dimension of the feature map corresponds to the height direction of the target image;
performing average pooling on the feature map in a width dimension of the feature map to obtain a pooled feature map;
segmenting the pooled feature map in the height dimension to obtain a preset number of features; and
determining the prediction category of each of the multiple stacked to-be-identified target objects according to each of the features.

19. The electronic device according to claim 18, wherein performing classification on the to-be-identified target object in the adjusted target image to determine the prediction category of the to-be-identified target object is executed by a neural network that comprises a classification network, and wherein the classification network comprises K classifiers, K being a number of known categories when classifying, K being a positive integer; and
wherein determining the prediction category of each of the multiple stacked to-be-identified target objects according to each of the features comprises:
respectively calculating cosine similarities between each of the features and a weight vector of each of the K classifiers; and
determining the prediction category of each of the multiple stacked to-be-identified target objects according to the calculated cosine similarities.

20. A non-transitory computer-readable storage medium coupled to the at least one processor and storing programming instructions for execution by the at least one processor to perform operations comprising:
performing classification on a to-be-identified target object in a target image to determine a prediction category of the to-be-identified target object;
determining whether the prediction category is correct according to a hidden layer feature for the to-be-identified target object; and
outputting prompt information in response to determining that the prediction category is incorrect.
